(19) United States
(12) Patent Application Publication
(10) Pub. No.: US 2026/0340699 A1
(43) Pub. Date: Oct. 29, 2026

(54) CAPTION-BASED RETRIEVAL ENHANCEMENT

(71) Applicant: eBay Inc., San Jose, CA (US)

(72) Inventors: Janet J. JENQ, Bellevue, WA (US); Hongda SHEN, Metuchen, NJ (US); Jiaying GONG, Harrison, NJ (US)

(21) Appl. No.: 19/189,908

(22) Filed: Apr. 25, 2025

(51) Int. Cl. G06Q 30/0601; G06F 16/22

(52) U.S. Cl. CPC G06Q 30/0627; G06F 16/2237

(57) ABSTRACT

This image caption generation model training device receives input of pairs of data, which are each a pair of an image serving as training data for generating an image caption and text data serving as a caption describing the image, and pairs of data each being a pair of first language text and second language text as machine translation data to train an image parameter serving as a model parameter for generating image hidden information, a text parameter serving as a model parameter for generating text hidden information, a cross-modal parameter serving as a model parameter for embedding cross-modal invariant information, and an output parameter serving as a model parameter for generating text.

### BACKGROUND

Users rely on item listing systems to organize and display products for sale, commonly used in e-commerce or inventory management. These systems enable efficient searching, sorting, and filtering of products based on various attributes like name, description, or category, ensuring accurate and streamlined product identification. There are several ways to identify products within these systems. Image recognition uses deep learning models, such as Convolutional Neural Networks (CNNs), to analyze product images and recognize visual features like shapes, colors, and logos. Barcode or QR code scanning is another method, allowing for instant product identification by reading unique codes linked to predefined data. Optical Character Recognition (OCR) is also widely used to extract text from images, such as product labels or packaging, and convert it into searchable data.

### SUMMARY

Various aspects of the technology described herein are generally directed to systems, methods, and computer storage media for, among other things, providing a caption-based enhanced retrieval engine that can utilize one or more machine learning engines, such as a multimodal artificial intelligence engine to generate a vector representation of an image and a product caption for one or more captions within an image. A vector representation for the product caption may be generated and the caption-based enhanced retrieval engine may combine the two vector representations into a product identifier which may be compared against a plurality of other product identifiers within a product index. Based on this comparison the caption-based enhanced retrieval engine may communicate a query response product identifier.

Accurately identifying products from images is a challenging task, especially when these images contain spatially related visual and textual elements. Traditional methods often fall short, as they either focus solely on image recognition or text extraction independently, leading to inaccuracies and inefficiencies. Current image recognition systems only capture so much information but do not have a method to capture the subtextual information from an image. For example, an image recognition system may analyze an image of a man playing in the park with his dog, and might output features that represent trees, dog, man and ball, but these features are often insufficient to capture a thorough understanding of an image or the products within the image.

The present technical solution addresses these limitations by generating a caption for an image utilizing a multimodal artificial intelligence engine which may then be transformed into a vector representation of the caption such that it can be stored in an index that is searchable based on received queries. The caption-based enhanced retrieval engine generates a caption from an image stored on an item listing system or received as part of a query. The image is then processed both to generate a vector representation of the features of the image as well as by a multimodal artificial intelligence engine to generate a caption that describes the image in text. The image may include any number of objects or products which the caption-based enhanced retrieval engine can process to generate a caption. A caption may be generated for each product within an image, one caption describing each product within the image, or may communicate a request to a user to select one or more products within the image which the caption-based enhanced retrieval engine may utilize to generate captions for the selected products.

The caption-based enhanced retrieval engine may transform the generated caption into a caption vector representing the textual description of the image. An image vector may also be generated for the image to capture the features and visual elements for the image, and the two vectors may be combined into a single product identifier. The product identifier may be utilized as part of a query or may be stored in an index that is searchable based on received queries. As such, the solution recited herein provides for a more robust product identification system which may capture visual features and textual subtext of images to improve query results.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1A illustrates a first example flow for generating and storing image and caption vectors, in accordance with aspects of the technology described herein.

FIG. 1B illustrates a second example flow for generating and storing image and caption vectors, in accordance with aspects of the technology described herein;

FIG. 1C illustrates an example image, in accordance with aspects of the technology described herein;

FIG. 2A is a block diagram of an image processing system computing environment, in accordance with aspects of the technology described herein;

FIG. 2B-1 and 2B-2 provide a flow diagram for generating image captions and image vectors to generate product identifiers which may be utilized based on a received query, in accordance with aspects of the technology described herein;

FIG. 3 provides a first exemplary method for generating and storing image identifiers based on generated captions, in accordance with aspects of the technology described herein;

FIG. 4 provides a second exemplary method for generating and storing image identifiers based on generated captions, in accordance with aspects of the technology described herein;

FIG. 5 provides a third exemplary method for generating and storing image identifiers based on generated captions, in accordance with aspects of the technology described herein;

FIG. 6 provides a block diagram of an exemplary item listing system computing environment suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION

### Overview

An item listing system and platform support storing items (products or assets) in item databases and providing a search system for receiving queries and identifying search result items based on the queries. An item (e.g., physical item or digital item) refers to a product or asset that is provided for listing on an item listing platform. Search systems support identifying, for received queries, result items from item databases. Item databases can specifically be for content platform or item listing platforms such as EBAY content platform, developed by EBAY INC., of San Jose, California. Item listing systems process incredible quantities of queries and transaction requests on a daily basis for incredible quantities of products listed on their systems. In order to efficiently store and process queries, item listing systems need quick and efficient methods for storing and querying accurate results. Conventionally, item listing systems store products based on user descriptions or metadata within images of products being uploaded. But the metadata and descriptions can only provide so much when utilized later on in future search.

Product identification and finding ways to efficiently store that product identification is a critical task with widespread applications in item listing systems, e-commerce, inventory management, and automated retail systems. Current technologies for product identification primarily rely on image recognition or text extraction independently. Some image recognition systems utilize deep learning models, such as Convolutional Neural Networks (CNNs), to analyze visual features of products. These systems can effectively identify products based on their visual appearance but often struggle in capturing the context or subtext of the products within an image.

Conventional item listing system relies on basic image recognition or keyword-based searches to identify and recommend products, which limits its ability to accurately identify specific product components, provide contextually relevant recommendations, and consistently match images with the correct product descriptions, leading to less precise and less meaningful results. For example, traditional item listing systems often face significant challenges when it comes to accurately identifying specific product components within images. Basic image recognition technologies can identify general categories of products, but they struggle to detect and describe intricate details, such as features or unique elements within the image. This limitation makes it difficult for users to find products based on specific visual characteristics, reducing the precision of product identification.

Furthermore, these systems often rely on basic keyword matching or image-to-text searches, which can result in inconsistent search results. Without a sophisticated understanding of the relationship between an image and its associated text, conventional systems may struggle to match the right product image with an accurate description or caption. This leads to irrelevant or mismatched results, frustrating users and hindering their ability to find the products they need.

Lastly, contextual relevance in product recommendations is often limited. Without an understanding of the context in which an image is presented—such as the specific features of a product or its intended use—a conventional system may recommend products that are not aligned with a user's query or preferences. This lack of contextual awareness reduces the accuracy and effectiveness of product recommendations, ultimately limiting the overall user experience.

For example, a user searching for a “wireless noise-canceling headphone” might upload an image of the product or search using related terms. However, basic image recognition might only identify the product as a “headphone,” missing crucial details such as its wireless capability or noise-canceling feature. As a result, the system could return a broad range of headphones, including wired models or those without noise-canceling features, frustrating the user who is specifically looking for wireless, noise-canceling options.

Additionally, if the system relies on keyword matching, it may fail to accurately associate the uploaded image with the correct product description. For instance, an image of a sleek, black wireless headphone could be incorrectly matched to a generic headphone listing with a different design or features because the system doesn't fully understand the specific visual and textual relationship. This inconsistency in matching images to descriptions leads to irrelevant search results.

Finally, the lack of contextual relevance in recommendations compounds the issue. If a user is searching for wireless, noise-canceling headphones to use during travel, the system might recommend random products instead of focusing on travel-friendly features, such as compact design or long battery life. This results in missed opportunities for offering truly relevant, tailored product recommendations. As such, a more comprehensive search engine—with an alternative basis for providing storage and search functionality—can improve computing operations and interfaces for item listing systems.

### Description of Technical Solution

At a high level, the caption-based retrieval enhancement engine is a system designed to improve product identification and retrieval in images. It generates vector representations of images and product captions using multimodal artificial intelligence. These vectors capture visual and contextual information about the products. The caption-based retrieval enhancement engine combines these vectors to create unique product identifiers, which are stored in a searchable product index. When a query is submitted, the caption-based retrieval enhancement engine processes a second image and caption associated with the query to generate a second product identifier. It compares this identifier to those in the index to find a match, enabling efficient cross-modal searching using images or text. The caption-based retrieval enhancement engine utilizes advanced AI techniques to generate detailed product captions and vector representations, enabling efficient and accurate product identification and retrieval across different modalities.

Operationally, the caption-based retrieval enhancement engine uses a multimodal artificial intelligence system to improve the accuracy and contextual relevance of product retrieval using image and caption data. The caption-based retrieval enhancement engine operates by first accessing an image that includes a product and generating a vector representation of the image using visual feature extraction. This image vector is stored in an image index that maintains a plurality of image vectors for subsequent retrieval and comparison.

Using a multimodal artificial intelligence engine, the caption-based retrieval enhancement engine then analyzes the image to generate a product caption. This caption comprises contextual data that describes the product shown in the image. If the image contains multiple products, the engine is configured to identify each of them and generate a separate caption for each, resulting in a plurality of product captions based on a single image. Each caption may be generated in response to a prompt requesting a description of a specific product or based on a user selection within the image. Once generated, the caption is converted into a vector representation, which is then stored in a product caption index comprising multiple caption vectors.

Traditionally, item listing systems have relied on human-generated or marketplace-sourced metadata, such as titles or descriptions, when generating item vectors for storage and search of items in an item listing system. While this improves basic accuracy and presentation, it does not address deeper challenges such as understanding user intent, detecting misleading content, or improving product discovery. As a result, these approaches may fall short in enhancing trust, relevance, and the overall shopping experience.

The technical solution proposed here addresses this gap by using high-quality and AI-generated image captions. The caption-based enhanced retrieval engine supports training machine learning models to generate image embeddings using AI-generated captions to improve visual similarity learning through contrastive methods, enabling richer, more accurate cross-modal retrieval and item discovery. By way of context, in modern machine learning systems, especially those that involve vision and language modalities, contrastive learning has emerged as a powerful approach to aligning representations from different domains—most notably, images and text. One prominent example of this is OpenAI's CLIP model, which learns to associate image embeddings with text embeddings by training on a large dataset of images paired with their corresponding natural language descriptions. During training, CLIP encourages embeddings of matching image-text pairs to be close together in a shared embedding space, while pushing apart the embeddings of mismatched pairs. This principle has also been applied to item listing systems, where listing images.

Operationally, rather than depending solely on existing metadata or descriptions, this method first employs an image captioning model—referred to here as Model A, such as a large vision-language model or multimodal variant of ChatGPT—to generate rich, detailed captions for each listing image. These captions can describe not only what the item is, but also its attributes, context, and functional characteristics. For instance, instead of just “men's shoes,” the caption might say “black leather running shoes with reflective trim and cushioned soles.”

Once the caption generation is complete for a dataset of listing images, these caption-image pairs are then used to train another model, referred to as Model B, which is responsible for learning image embeddings. The training objective for Model B adopts a contrastive learning framework. It aims to learn an embedding space where images with semantically similar captions are embedded close to one another, while images with unrelated or dissimilar captions are pushed further apart. In this sense, Model B learns to understand visual similarity through the lens of textual semantics, but without relying on manual labeling or inconsistent descriptions.

This training approach has several notable advantages. First, because the captions are generated by a consistent language model (Model A), they provide a high-quality, uniform semantic grounding across the dataset. Second, this method effectively decouples the caption generation and embedding training tasks, allowing each model to be optimized independently. Model A can focus on generating nuanced descriptions, while Model B can focus on learning high-fidelity visual representations that align with those descriptions. Third, this framework naturally supports scalability: once trained, Model B can embed any image—regardless of whether it has accompanying metadata—into a shared space where semantically similar items cluster together.

Moreover, this approach also opens up new possibilities for improving cross-modal search and retrieval systems. Because Model B is trained using captions that are rich in descriptive detail, the resulting image embeddings are more semantically meaningful and can support more accurate matching, even when the user query is text-based. For instance, a user typing “red backpack with roll-top closure and side water bottle pockets” could retrieve visually relevant images, even if those images never had human-written descriptions matching the query. This enables a powerful zero-shot or few-shot capability for product discovery. Using AI-generated image captions as supervisory signals for contrastive training represents a novel and effective enhancement to traditional item embedding pipelines. It leverages recent advances in multimodal AI to create better-aligned, semantically meaningful visual representations, and improves the performance and flexibility of downstream systems like search, recommendation, and classification.

Imagine you have thousands of product images from an online marketplace. One image shows a red backpack with a roll-top closure, black straps, and mesh side pockets for water bottles. Traditionally, this image might be paired with a sparse title like “red backpack”—a vague and insufficient description for training a meaningful image embedding. With this new solution, Model A (e.g., a large vision-language model) is used to generate a detailed caption for that image. “A red roll-top backpack with black adjustable straps and mesh side pockets, suitable for hiking or school use.” This is repeated for an entire dataset, now pairing each image with a high-quality, automatically generated caption.

Then, Model B, image embedding model, is trained using contrastive learning: positive pairs are each image and its corresponding caption; and negative pairs are images and captions that describe different products (e.g., pairing the red backpack image with a caption describing running shoes. The model learns to pull the backpack image and its caption closer in the embedding space, while pushing dissimilar ones apart. Later, a user submits a search query: “Backpack with roll-top and water bottle holder”. Even though that specific phrase doesn't exist anywhere in your catalog metadata, the system uses Model B's embeddings to retrieve the red backpack image—because its visual embedding was trained to align closely with such a descriptive caption.

To associate the visual and textual representations, the caption-based retrieval enhancement engine combines the image vector with the caption vector. This combination is performed via concatenation, resulting in a joint vector embedding that captures both the visual characteristics and the semantic context of the product. This joint vector is used to generate a unique product identifier, which is stored in a product index alongside other product identifiers. Each product identifier may also be linked with a product name to further facilitate identification and searchability. The product index is structured to support cross-modal search, enabling users to submit either image-based or text-based queries to retrieve relevant results.

When a query is submitted, the caption-based retrieval enhancement engine accesses the query input, which typically includes a second image of a product. A second image vector is generated, and the multimodal engine produces a second caption that describes the product in the query image. The caption is converted into a second caption vector, and these two vectors are concatenated to generate a second product identifier. The system then performs comparisons between the second product identifier and the product identifiers stored in the product index. It also compares the second image vector to entries in the image index and the second caption vector to entries in the caption index. Based on the results of these comparisons, the system identifies a query response product identifier that most closely matches the input query.

The caption-based retrieval enhancement engine then communicates the image associated with the query response product identifier back to the user. If the image includes multiple products, the caption corresponding to the selected or relevant product is used. The query response product identifier may also be stored in a query response index in association with the second product, enabling future refinement and reinforcement of the retrieval system. The caption-based retrieval enhancement engine, by jointly embedding visual and textual data and indexing this information across multiple dimensions, enables accurate and context-aware retrieval of product information from a wide array of input types.

The caption-based enhanced retrieval engine may specifically detect the presence of a number of products within an image and generates a caption for each product within the image. In additional or alternative embodiments, the caption-based enhanced retrieval engine may detect the products and then communicate a request to a user to select one or more products within the image for the caption-based enhanced retrieval engine to generate a caption. Therefore, the caption-based enhanced retrieval engine may analyze an image to recognize and generate captions for any number of products within the image. The caption-based enhanced retrieval engine uses a multimodal artificial intelligence engine that analyzes multiple items in an image is the level of complexity and the need for user interaction.

In a single-item vision model, the system is designed to identify and analyze just one object in the image. The model typically processes the image and makes a prediction or analysis based on the single item it detects. This is simpler and more straightforward. In order to recognize and analyze multiple products within a single image, the multimodal artificial intelligence engine of the caption-based enhanced retrieval engine includes a multi-item vision model. This multi-item vision model system may first identify multiple objects in an image, typically using object detection algorithms like YOLO (You Only Look Once) or Faster R-CNN (Region-based Convolutional Neural Networks). Once the objects are detected, a user interaction model may be used to allow the user to select specific items for further analysis. This could involve displaying bounding boxes around the detected items and letting the user click on or highlight the item they want to analyze in more detail.

For example, imagine a shopping app that uses computer vision to analyze a product image. For a single-item model, it could identify a single item in the picture, such as a shirt, and provide details about that shirt. In contrast, for a multimodal artificial intelligence engine, if the user uploads a picture with multiple items (like a group of clothing items), the multimodal artificial intelligence engine would first detect all the items (e.g., shirts, pants, shoes) and display them in separate bounding boxes. The user could then click on the specific item they want more information about, like a particular shirt, and the system would provide detailed information on that specific item. As such, the technical solution described herein utilizes a multimodal artificial intelligence engine which may detect and analyze any number of products within an image in order to generate a caption for the image textually describing the products within the context of the image. The multimodal artificial intelligence engine supports the design of the caption-based retrieval enhancement engine to improve product identification and retrieval in images.

### Example System and Resources

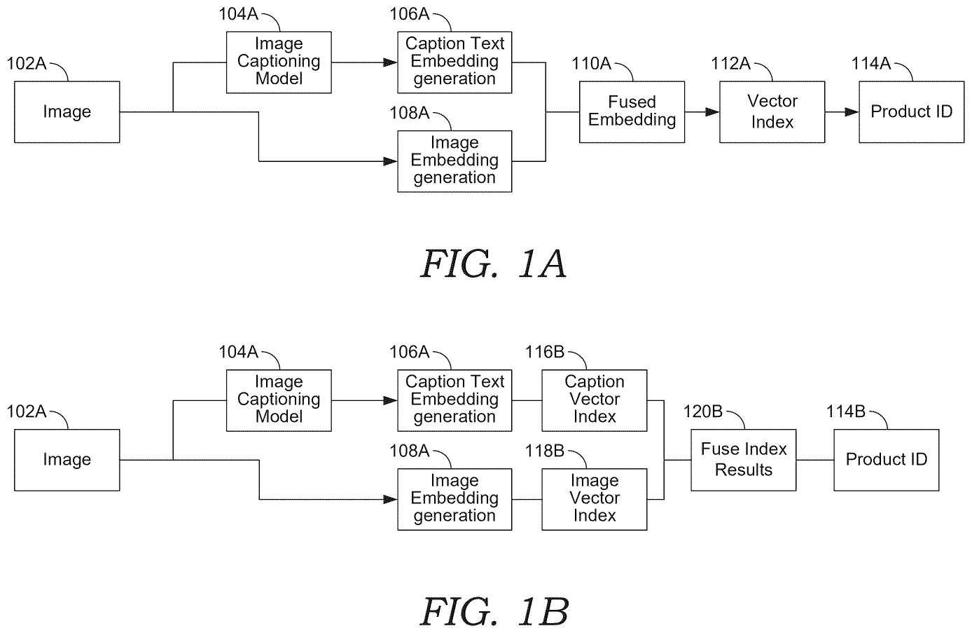

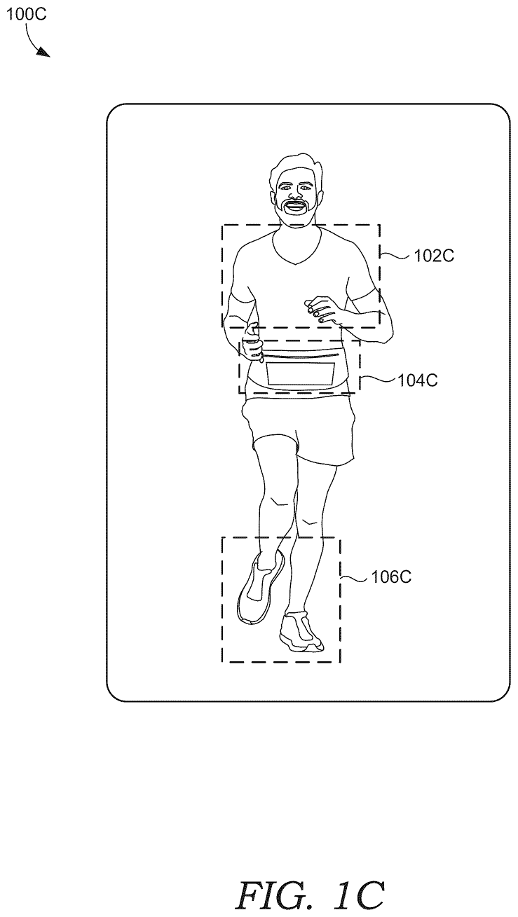

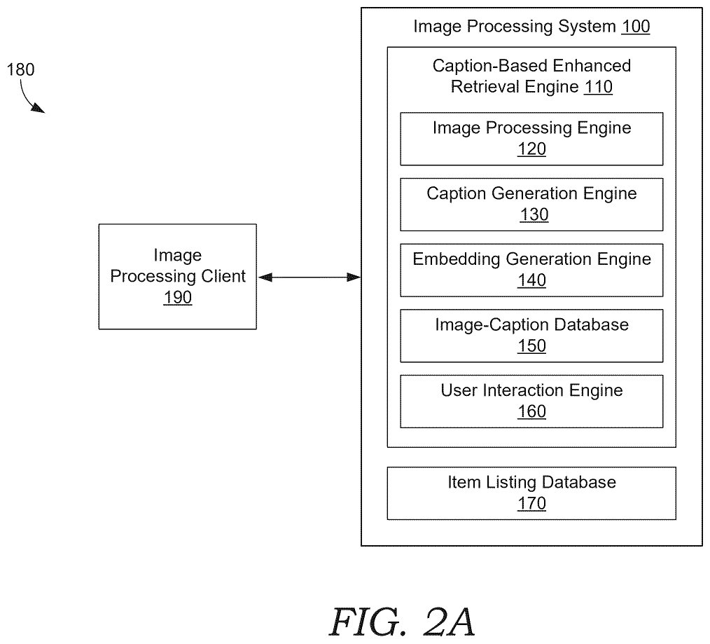

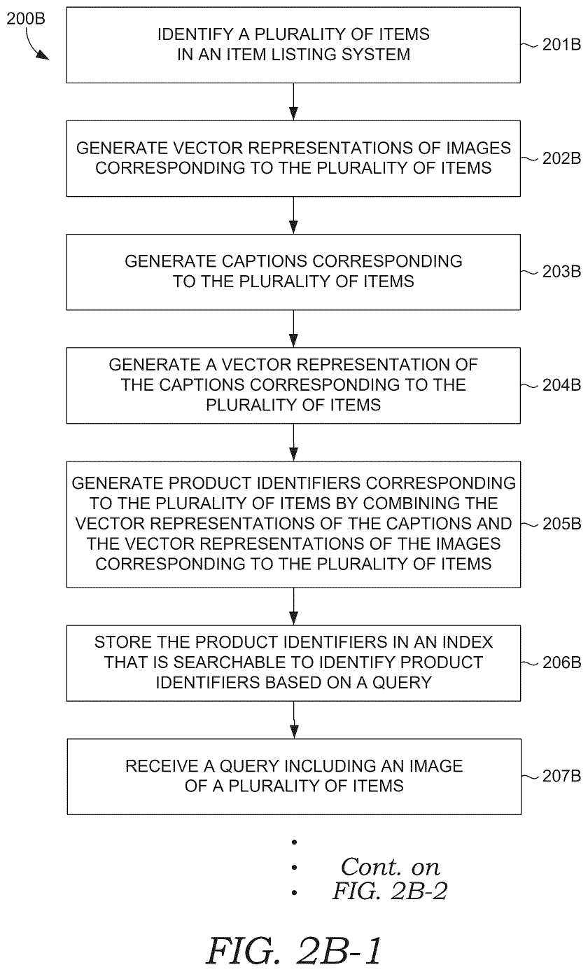

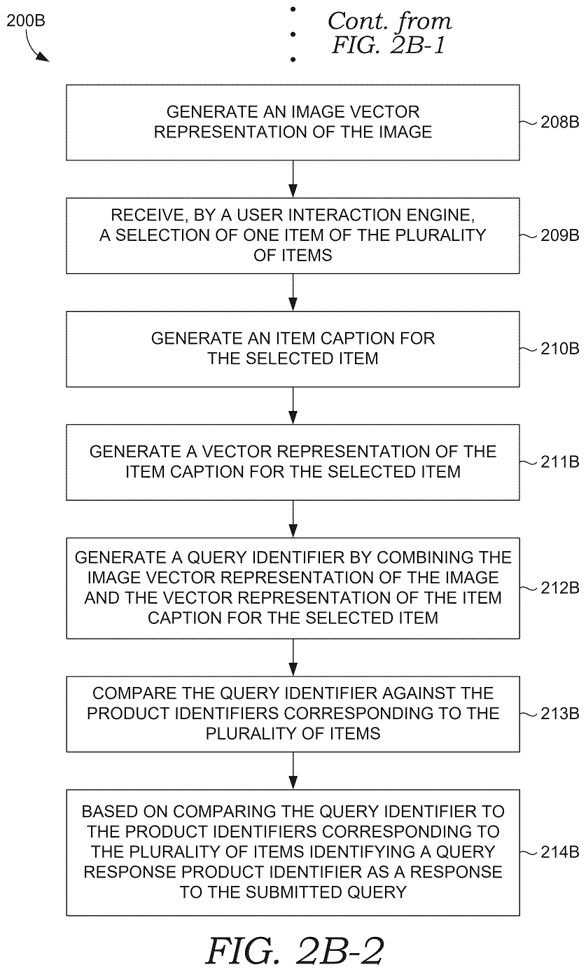

Aspects of the technical solution can be described by way of examples and with reference to FIGS. 1A-1B . FIG. 1A illustrates a first example flow for generating and storing image and caption vectors, in accordance with aspects of the technology described herein, and FIG. 1B illustrates a second example flow for generating and storing image and caption vectors, in accordance with aspects of the technology described herein. Both flows of FIGS. 1A and 1B begin by receiving or accessing an image 102A. For example, the image 102A may be received as part of a query made to an item listing system. The image 102A may be already stored within a database of an item listing system such as the item listing database 170 discussed in relation to FIG. 2A. The image 102A may comprise any number of objects and any number of products within the image.

As discussed throughout, the caption-based enhanced retrieval engine may determine which objects within the image are products to be processed, or the caption-based enhanced retrieval engine may transmit a request for a user to select one or more objects within the image for the caption-based enhanced retrieval engine to generate image and caption vectors as discussed in more detail below. As such, each step discussed herein may be conducted for any number of objects or products within an image and may be conducted in response to a selection of any number of objects or images within the image.

Whether the image 102A is received as part of a query or is accessed from a database, the image may be processed to generate several things. The image 102A may then be processed to generate a vector representation of the image and caption for the image. The caption for the image 102A may be generated by a multimodal artificial intelligence engine-designated as image captioning model 104A. In embodiments, the image captioning model 104A may be a recurrent neural network or a transformer model that may analyze the data within the image to generate a verbal description of the image. In embodiments, the image is accessed directly by the multimodal artificial intelligence engine such that the input of the multimodal artificial intelligence engine is image data and the output is a verbal description of the image data. In additional or alternative embodiments, the image may be preprocessed to generate a set of vectors or other machine readable representations of the image data which may then be accessed or analyzed by the multimodal artificial intelligence engine.

The image captioning model 104A generates a verbal description of the image in the form of a caption. For example, a user may upload an image of an individual playing fetching the park with their dog. A normal vector representation of this image may capture information such as dog, ball, human, shoes, shirt, and things of that nature. But the context and subtext of the image may be lost in standard vector representation. To avoid losing important contextual and subtextual information from the image 102A, the caption can be generated to describe, for example, a human playing fetch in a park with their dog while wearing a branded shirt and hiking boots. This caption provides further details and may focus on data within the image 102A that is not captured by a standard vector representation of the image 102A. Once the caption has been generated by the image captioning model 104A, a caption embedding may be generated in the caption text embedding generation 106A step. In the caption text embedding generation 106A step, the verbal or textual data generated by the image captioning model 104A may be transformed into a vector representation of the textual data.

The image 102A may be processed to generate a vector representation of the image 102A for example through the utilization of a convolution neural network which can generate image embeddings by processing visual data and extracting high-level features from the image 102A. The image embedding generation 108A step can occur before the caption text embedding generation 106A step, in tandem with the caption text embedding generation 106A step, or afterwards. This image embedding generation 108A step may result in an embedding comprised of a vector representation of features within the image 102A. As such, after the caption text embedding generation 106A step and the image embedding generation 108A step, the caption-based enhanced retrieval engine has generated two vectors, one representing the caption generated based on processing the image by a multimodal artificial intelligence engine, and one representing the image itself as analyzed by a second machine learning model such as a convolution neural network. This is where the differences between the first flow of FIG. 1A and the second flow of FIG. 1B begin.

Starting with FIG. 1A, the caption embedding generated as a result of the caption text embedding generation 106A step and the image embedding generated as a result of the image embedding generation 108A step may be combined to create a fused embedding 110A. This fused embedding may be generated by concatenating the two vectors, by utilizing a weighted sum to combine the two vectors, or through attention mechanisms. Any method may be used to fuse or combine the two vectors in order to generate the resultant fused embedding 110A. Given that it is generated based on a caption vector and an image vector, the resulting fused embedding 110A will capture more contextual and subtextual information than an embedding generated solely from an image vector or metadata. This fused embedding 110A may be stored within a vector index 112A in association with a product ID 114A.

The caption-based enhanced retrieval engine may store the fused embedding 110A in the item listing database such as item listing database 170 of FIG. 2A, or may store the fused embedding 110A in the image-caption database 150 of FIG. 2A, or it may be stored in both. Storing the two vectors in a single fused embedding 110A may reduce the amount of physical storage needed to store embeddings in an item listing system. This provides for efficient storage and use of limited computing storage, but given the complexity of the resultant embedding may comprise slightly longer query processing times. This is where the second example flow of FIG. 2B comes in.

The second example flow for generating and storing image and caption vectors also includes generating a caption embedding and an image embedding. But instead of fusing these two embeddings after they are generated, they are instead stored in two separate indexes. In this embodiment, the caption embedding is stored in a caption vector index 116B and the image embedding is stored in the image vector index 118B. In this manner, the two embeddings may be stored and processed separately when submitted as a query or when stored within a system such that they may be utilized in determining results that match a query. This may require additional use of storage hardware but as both indexes may be queried simultaneously, the processing speeds can be increased in comparison to the flow of FIG. 1B.

Once a query has been submitted, the two indexes may be queried and return the most representative product from the caption vector index 116B and the most representative product from the image vector index 118B. These results may be compared against one another and used to determine a matching product, after the matching product is identified, the flow may constitute fuse index results 120B such that the caption vector and the image vector for the resulting product are fused together and stored in association with a product ID. In embodiments, the caption vector index 116B and the image vector index may both be stored in the item listing database 170 or the image-caption database 150C and may be stored as a product ID 114B for the associated product.

These above described steps illustrate two embodiment in which an image may be processed to generate a caption embedding and an image embedding which may be utilized to generate product identifiers which may be stored in a product index of an item listing system, the product index being searchable to identify product identifiers based on submitted queries. In this manner, the caption data may be used to efficiently determine types of products that are similar to the product in the provided image by utilizing more contextual and subtextual information than simply storing image vector or metadata. The caption-based enhanced retrieval engine may utilize the caption information to efficiently store and search an item listing database or vector index to quickly determine similar products using the caption data to provide more accurate results.

As such, the caption-based enhanced retrieval engine introduces a novel approach to product identification by tightly integrating image and text data through a multimodal artificial intelligence framework. The caption-based enhanced retrieval engine operates by processing an image that may include several products. Instead of limiting the analysis to a single object, it utilizes advanced object detection models to identify multiple items simultaneously. Each detected item is isolated, and the caption-based enhanced retrieval engine either automatically generates individual product captions or prompts the user to select one or more products of interest. This user interaction adds a layer of precision, allowing the system to generate highly relevant captions based on the selected object. Each caption is then transformed into a vector representation and combined with the image vector to create a unique product identifier. These identifiers are stored in a product index that supports cross-modal queries, meaning users can submit either an image or a textual description and receive accurate, contextually relevant results.

Moreover, the caption-based enhanced retrieval engine supports understanding and encoding not just what a product looks like, but what it is and how it exists within its visual context. For example, consider a user who uploads an image featuring a kitchen counter with several items: a coffee maker, a toaster, and a blender.

A conventional system might attempt to match the entire image to a single known item or fail to disambiguate among the products. In contrast, the caption-based enhanced retrieval engine detects all three appliances, generates a distinct caption for each—such as “sleek stainless steel drip coffee maker,” “two-slot black toaster with crumb tray,” and “compact glass blender with three-speed setting”—and allows the user to select one for deeper analysis or search. If the user selects the coffee maker, the system isolates its visual and contextual attributes, generates a combined embedding, and queries the product index for similar items, returning detailed product matches along with enriched captions and related images.

This layered fusion of vision, language, and user interaction creates a highly adaptive and intelligent retrieval experience that mirrors how humans understand and describe objects. It is particularly advantageous in domains such as e-commerce, visual cataloging, and interactive shopping assistants, where recognizing the specific item of interest among many is essential to delivering meaningful results.

With reference to FIG. 1C, FIG. 1C illustrates an example implementation of the caption-based enhanced retrieval engine in operation. In FIG. 1C, image 100C contains a person engaged in jogging, and the multimodal artificial intelligence engine has identified multiple distinct product regions within the image. The multimodal artificial intelligence engine employs a multi-item vision model to detect these individual product instances, which are represented by bounding boxes labeled 102C, 104C, and 106C. Bounding box 102C corresponds to the upper body region of the person, potentially identifying a wearable product such as a shirt. Bounding box 104C focuses on the waist area, where the system may identify a product like a running belt or fanny pack. Bounding box 106C isolates the lower body, which may include running shoes.

By way of context, a multimodal artificial intelligence engine is designed to process and integrate multiple types of data, or “modalities,” such as text, images, audio, and video, using a multimodal model at its core. The multimodal artificial intelligence engine enables AI to understand and generate outputs across diverse data forms, facilitating complex tasks that require reasoning across multiple inputs. A multimodal model in this context is capable of analyzing and combining different types of information to generate responses or outputs, such as text, images, or videos, based on the integrated data. Additionally, specific types of multimodal models, like vision-language models, focus on the combination of visual (images or videos) and textual data to perform tasks like image captioning, visual question answering, or generating images from text prompts. Overall, a multimodal artificial intelligence engine enhances the system's ability to perform more sophisticated, human-like interactions by leveraging diverse data types in a unified framework.

Operationally, the caption-based enhanced retrieval engine may transmit a request for a user to select one or more of the items, and based on receiving the selection, the caption-based enhanced retrieval engine generates a caption for the selected items. As shown, in FIG. 1C, each of the product regions can be automatically processed by the multimodal artificial intelligence engine to generate a distinct caption describing the detected item in context—for example, “moisture-wicking athletic t-shirt,” “zippered running belt for carrying phone and keys,” and “cushioned road-running shoes.” This caption provides more context to the image than merely identifying objects or features of the image. As such, this caption can then be processed by the caption-based enhanced retrieval engine to generate a vector, and the vector will capture the context of throwing the ball to a pet on a sunny day. This type of information helps to distinguish between a red shirt that may be worn on a cool day, or that is worn while doing a more or less intense activity.

The technical solution exemplified in FIG. 1C highlights the novel ability of the caption-based enhanced retrieval engine to not only detect multiple products in a single image, but also to generate contextualized descriptions for each product individually. These product-specific captions can then be embedded and associated with image vectors to form unique product identifiers, enabling precise cross-modal retrieval based on either image or text-based queries. In practice, this figure may represent a scenario where a user uploads a photo of a person in athletic gear, and the caption-based enhanced retrieval engine disambiguates the various products visible to support refined, item-level search and recommendation results.

With reference to FIG. 2A, FIG. 2A provides an example image processing computing environment 180 comprising an image processing client 190 and an image processing system 100 is depicted. The image processing client 190 may receive or access images either included in a database such as the item listing database 170, or from a user device. The image processing client 190 may receive interactions at a graphical user interface of a user device. For example, if a user provides an image that has more than one product within the image, the caption-based enhanced retrieval engine 110 may determine what objects within the image are products and communicate a request for the user to select one or more of the products included within the image.

In embodiments, the request for selection may be communicated and processed by the user interaction engine 160. A user may also provide further clarification text or images through the image processing client 190. This may also be processed by the user interaction engine 160. For example, a user may submit a query comprising an image that has three objects. The caption-based enhanced retrieval engine 110 may determine that two of the objects in the image are products, and the third object of the image is not a product.

The user interaction engine 160 may communicate a request to the image processing client 190 to display on a graphical user interface a plurality of response options of which product the user would like to search. The image processing client 190 may receive a selection of one of the response options and based on this selection, the user interaction engine 160 may determine which object or objects in the image to process and utilize in a search or to be stored within either the image-caption database 150 or the item listing database 170. In embodiments, the user may also indicate that the third object, not originally recognized is to be used in the search, or may indicate more than one object in the image as products to be searched.

The image processing system 100 may receive or access images or queries to generate embeddings from the image and a caption generated by processing the image to query a database of embeddings such as the image-caption database 150 or the item listing database 170. The caption-based enhanced retrieval engine 110 may additionally or alternatively generate the embeddings and store them within the image-caption database 150 or the item listing database 170 such that they may be utilized in future searches.

In embodiments, the caption-based enhanced retrieval engine 110 accesses images and product information from the item listing database 170 and utilizes these images to generate product identifiers for the products within the images by generating captions, caption vectors, and image vectors as described herein. Once generated, these new product identifiers including the caption data may be stored in the image-caption database 150, the item listing database 170, or both. The caption-based enhanced retrieval engine 110 utilizes several engines and data sources in generating the caption-based identifiers. Namely, the caption-based enhanced retrieval engine 110 may utilize an image processing engine 120, a caption generation engine 130, an embedding generation engine 140, an image-caption database 150 and a user interaction engine 160 to generate the caption-based identifiers.

The image processing engine 120 may analyze an image comprising any number of objects and may generate a vector representation of the image based on analyzing the image to generate a vector representing the features and objects within the image. The image processing engine 120 may be a multimodal artificial intelligence engine configured to identify features of an image and generate textual descriptions of an image to capture contextual and subtextual relationships within the image. The caption generation engine 130 may process the image to generate a text based description of the entire image or of the objects within the image.

In embodiments, the caption-based enhanced retrieval engine 110 may determine that numerous objects are included within the image. An illustrative example of such an image is included as FIG. 1C. As can be seen in FIG. 1C, an image 100C may comprise for example an individual out for a run. That individual may be wearing a shirt, 102C, a fanny pack 104C, and shoes 106C. The caption-based enhanced retrieval engine 110 may identify each of these three objects and communicate a request to a user to select any number of the objects.

Based on the selection, the caption generation engine 130 of the caption-based enhanced retrieval engine 110 may generate a caption for the product in the context of the overall image 100C. For example, if a user selects the shirt 102C, the caption generation engine 130 may generate a caption such as a red shirt being worn by a man running through the forest while sweating with effort. This caption provides more context than simply identifying a shirt or identifying that it is worn by a man. If a user selects a different object, or more than one object, the caption generation engine 130 may generate a separate caption for each item in the context of the image, or may generate a single caption that includes a description of all of the selected items within the context of the image. The caption generation engine 130 may also generate a caption vector from the generated caption.

The embedding generation engine 140 may utilize image vector generated by the image processing engine 120 and the caption vector generated by the caption generation engine 130 to generate a product identifier for the image comprising the product. As used herein, a product identifier may be generated for each product within an image, or a single product identifier could be generated for all products within a single image. The image embeddings may be generated by the embedding generation engine 140 by any known method such as transforming the text and bounding box data into vector representations of the text and bounding box data.

In embodiments a single embedding may be generated for the caption vector and the image vector. In additional or alternative embodiments, separate embeddings, such as a caption embedding and an image embedding may be generated and used to generate a caption-based identifier and an image-based identifier and stored separately or in association with one another. The caption-based enhanced retrieval engine 110 may store the identifier or identifiers generated by the embedding generation engine 140 in an index that is searchable to identify identifiers based on a query associated with a query bounding box. The index may be located in the text-bounding box database 150 or the item listing database 170.

In embodiments, the caption-based enhanced retrieval engine 110 may utilize all of the data generated, extracted, or determined by the image processing engine 120 caption generation engine 130, and embedding generation engine 140 to generate identifiers that may be used to identify products based on each set of information, or may utilize the generated caption to identify products based solely on the caption of the product. Said another way, the product identifier does not need to comprise both the caption vector and the item vector. The caption-based enhanced retrieval engine 110 may generate embeddings and identifiers based solely on the caption generated by the caption generation engine 130. Additionally, the caption-based enhanced retrieval engine may generate a single image identifier that comprises the image data and the caption data for each product within an image or may generate a separate product identifier for each product within the image, or the products or product selected by a user.

With reference to FIG. 2B, FIG. 2B, is a flow diagram for generating image identifiers captions and image vectors to generate product identifiers which may be utilized based on a received query, in accordance with aspects of the technology described herein. The technical solution of the caption-based enhanced retrieval engine can be explained by way of steps and an example of processing a request to access a secure resource.
FIG. 2B—Index Generation Phase
Step 201B—Identify a plurality of items in an item listing system

The caption-based enhanced retrieval engine begins by scanning a collection of product data or images to identify a plurality of distinct items suitable for indexing. These items may exist across various contexts—such as lifestyle images, product catalogs, or user-generated content—and may include multiple products in a single image. The caption-based enhanced retrieval engine is configured to distinguish between different types of items, such as apparel, accessories, or electronics, using object detection algorithms. Each identified item is marked for downstream processing, including visual analysis and caption generation. This step forms the foundation of the index and ensures broad coverage across product categories and visual contexts
Step 202B—Generate vector representations of images corresponding to the plurality of items

For each identified item, the caption-based enhanced retrieval engine generates a vector representation of the image containing the item using computer vision techniques. These image vectors are numerical embeddings that encode visual features such as shape, color, texture, and spatial positioning. The visual encoder may use a convolutional neural network (CNN) or vision transformer model to extract discriminative features from the images. These embeddings serve as the image-based foundation of the retrieval system, allowing future queries to be matched based on visual similarity. The result is a high-dimensional representation that encapsulates the appearance of each product in a searchable format.
Step 203B—Generate captions corresponding to the plurality of items

The caption-based enhanced retrieval engine utilizes a multimodal artificial intelligence engine to generate descriptive captions for each product detected in the images. A multimodal artificial intelligence engine may be provided an image, such as image 100C, and a prompt requesting that the multimodal artificial intelligence engine provide a description of the image. An example prompt may comprise, “describe the products within this image.” Or, if the caption-based enhanced retrieval engine has received a selection of an item within the image from a user, the prompt may be specific to the selected item. For example, the prompt may comprise “describe the shoes in this image.” These captions go beyond simple labels and include contextual and semantic information—such as material, function, color, and usage scenarios. For instance, instead of simply labeling a product as “shoes,” the caption may describe it as “black running shoes with breathable mesh and white soles.” If multiple items are present in a single image, the engine generates a caption for each item individually. This enhances item-level understanding and supports detailed product retrieval based on text-based input or hybrid queries.
Step 204B—Generate a vector representation of the captions corresponding to the plurality of items

Once captions are generated, the caption-based enhanced retrieval engine encodes each one of the captions into a vector representation. These caption vectors reflect the semantic meaning of the textual descriptions, capturing relationships, attributes, and context in a high-dimensional space. This vectorization enables comparison between captions and supports text-based search and retrieval. The caption vectors are aligned with the corresponding image vectors to ensure compatibility in a shared embedding space. This dual-representation framework allows the system to bridge the gap between visual and linguistic modalities and enables precise product identification using either modality.
Step 205B—Generate product identifiers corresponding to the plurality of items by combining the vector representations of the captions and the vector representations of the images

To create a unique product signature for each item, the caption-based enhanced retrieval engine combines the image vector and the caption vector into a joint embedding. This is typically done through vector concatenation or a learned fusion model that captures multimodal correlations. The resulting product identifier represents a comprehensive understanding of the item, combining both how it looks and what it is. This embedding becomes the searchable key for that product in the index. By merging visual and semantic data, the system increases robustness and disambiguation capability, allowing it to distinguish between visually similar but semantically different products and vice versa.
Step 206B—Store the product identifiers in an index that is searchable to identify product identifiers based on a query

Each product identifier is stored in a structured index designed for efficient querying and retrieval. This product index supports nearest-neighbor search in high-dimensional space, enabling fast and accurate matching. The index allows incoming queries—whether image-based, caption-based, or combined—to be compared against the stored product identifiers to retrieve relevant results. Metadata such as product names, categories, and URLs may also be associated with each identifier for downstream use. The index may be updated dynamically as new items are added. It forms the backbone of the retrieval engine, enabling scalable cross-modal search across vast product inventories.
FIG. 2B—Query Processing Phase
Step 207B—Receive a query including an image of a plurality of items

The caption-based enhanced retrieval engine receives a user-submitted query that includes an image containing multiple items. This may occur in a use case such as mobile shopping, where a user uploads a photo with several products—for example, someone jogging with a shirt, smartwatch, and shoes. The engine detects that the image includes multiple items and prepares to analyze them individually. At this stage, the system does not yet know which product is of interest to the user. It prepares to perform multimodal analysis and optionally engage the user to disambiguate their intent, ensuring more accurate and personalized retrieval results.
Step 208B—Generate an image vector representation of the image

The caption-based enhanced retrieval engine processes the entire query image to generate a vector representation that encodes its visual characteristics. This vector serves as a compressed, high-dimensional signature of the image content and is used to compare against image vectors in the product index. Although the image contains multiple items, the vector captures the full visual context. This step ensures that the retrieval system can reason about the appearance of the query input and later refine it to focus on a specific product through user interaction or object-level segmentation. It also enables fast similarity comparisons during search.
Step 209B—Receive, by a user interaction engine, a selection of one item of the plurality of items

To resolve ambiguity in multi-item images, the caption-based enhanced retrieval engine includes a user interaction engine that prompts the user to select one product of interest. This can be done via visual UI elements such as bounding boxes or thumbnails overlaying the detected items. For instance, if the image includes both a shirt and a smartwatch, the user may tap on the smartwatch to indicate their focus. This selection helps the system narrow down the query scope and improves caption accuracy and downstream matching. The system records this selection and routes it to the caption generation module for focused analysis.
Step 210B—Generate an item caption for the selected item

After the user selects an item, the caption-based enhanced retrieval engine generates a detailed caption specific to that product. The caption captures key attributes—such as brand-like appearance, material, color, and usage context—and reflects the product's role in the visual scene. The multimodal artificial intelligence engine tailors this caption to the exact object selected rather than the overall image. For example, if a running belt is selected, the caption may read “compact zippered waist pouch with elastic straps, worn during jogging.” This improves semantic precision and ensures that only the chosen product is described, aligning user intent with system output.
Step 211B—Generate a vector representation of the item caption for the selected item

Once the caption for the selected product is generated, it is converted into a high-dimensional vector using a language model. This vector captures the semantic meaning of the caption and allows it to be compared with caption vectors in the product index. It is crucial that this caption vector is compatible with the earlier vector formats generated during indexing to ensure consistent retrieval performance. This representation enables the system to reason not only about the visual features of the selected item but also its linguistic description, thus supporting multimodal fusion for query formulation.
Step 212B—Generate a query identifier by combining the image vector representation of the image and the vector representation of the item caption for the selected item

The caption-based enhanced retrieval engine generates a query identifier by combining the image vector and the caption vector for the selected product. This fused embedding acts as a precise query fingerprint that reflects both the appearance and semantic description of the selected product. The fusion process ensures that the final query vector captures visual-textual alignment, supporting robust retrieval from the product index. This query identifier is then prepared for comparison against all indexed product identifiers, allowing the system to locate the best match within the database. It forms the core mechanism for high-fidelity, multimodal search.
Step 213B—Compare the query identifier against the product identifiers corresponding to the plurality of items

The generated query identifier is matched against all product identifiers stored in the product index. This is done using similarity comparison techniques—such as cosine similarity or approximate nearest-neighbor search—to find the closest matches. Because the query identifier is multimodal, it can be compared fairly to product identifiers that also combine image and caption vectors. This step leverages the index's structure to identify the most relevant items, even if they were captured under different conditions or from different angles. The system selects the top matches that best correspond to the input image and description.
Step 214B—Based on comparing the query identifier to the product identifiers corresponding to the plurality of items, identifying a query response product identifier as a response to the submitted query

From the comparison results, the caption-based enhanced retrieval engine identifies the product identifier that best matches the user's query. This query response product identifier corresponds to the item most semantically and visually similar to the selected item in the submitted image. The engine may return associated metadata, such as product images, names, or purchase links, depending on the application. This final step completes the retrieval loop, allowing the user to see results that directly reflect their intent. By using both image and caption data, the system ensures greater retrieval accuracy and relevance compared to traditional vision-only or text-only approaches.

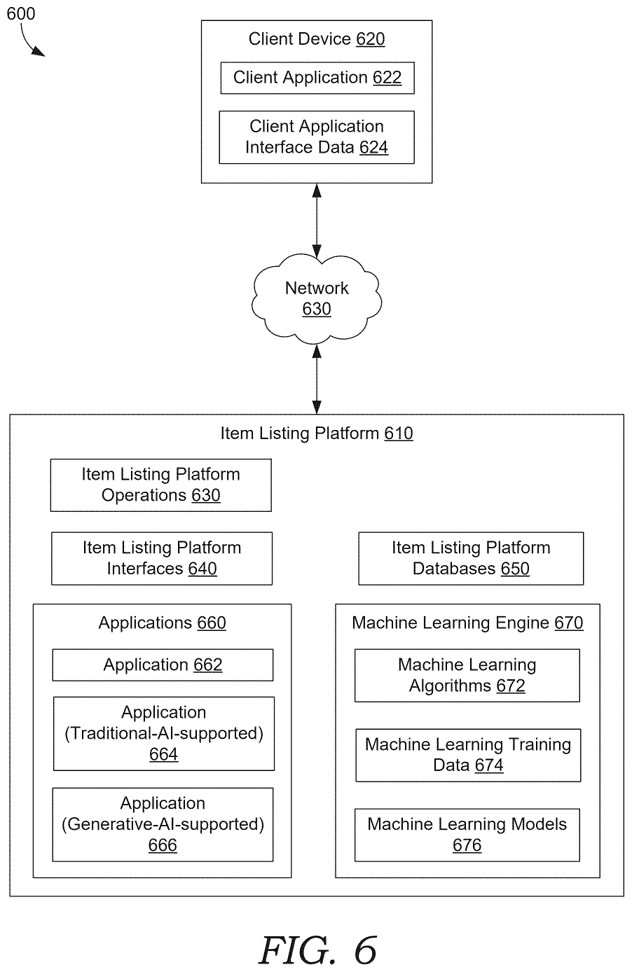

Aspects of the technical solution can be described by way of examples and with reference to FIGS. 1A, 1B, 2A, and 2B. FIG. 2A is a block diagram of an exemplary technical solution environment, based on example environments described with reference to FIGS. 6, 7, and 8 for use in implementing embodiments of the technical solution are shown. Generally the technical solution environment includes a technical solution system suitable for providing the example item listing system 600 in which methods of the present disclosure may be employed. In particular, FIG. 2A shows a high-level architecture of the image processing system 100 in accordance with implementations of the present disclosure. Among other engines, managers, generators, selectors, or components not shown (collectively referred to herein as “components”), the image processing system 100 of FIG. 2A support functionality described in FIGS. 1A and 1B.

### Example Methods

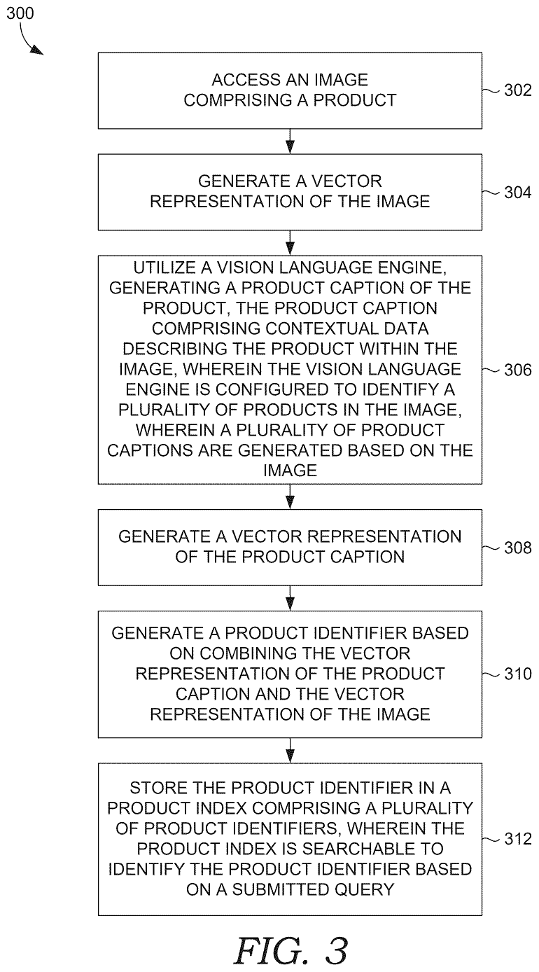

With reference to FIGS. 3, 4, and 5 flow diagrams that illustrate methods for generating a storing image identifiers based on generated captions, in accordance with aspects of the technology described herein. The methods may be performed using the artificial intelligence and image processing system described herein. In embodiments, one or more computer-storage media having computer-executable or computer-useable instructions embodied thereon that, when executed, by one or more processors can cause the one or more processors to perform the methods (e.g., computer-implemented method) in an artificial intelligence system (e.g., computerized system or computer system).

Turning to FIG. 3, a flow diagram is provided that illustrates a method 300 for generating and storing image identifiers based on generated captions. The image may comprise a plurality of products wherein a plurality of product captions are generated based on the image. At block 302, access an image comprising a product. At block 304, generate a vector representation of the image.

At block 306, utilizing a multimodal artificial intelligence engine, generate a product caption of the product, the product caption comprising contextual data describing the product within the image, wherein the multimodal artificial intelligence engine is configured to identify a plurality of products in the image, wherein a plurality of product captions are generated based on the image. The product caption may be generated based on receiving a selection of one of a plurality of products within the image. A plurality of product captions may be generated based on the image. The product caption may be generated based on a prompt requesting a description of the product within the image.

At block 308, generate a vector representation of the product caption. At block 310, generate a product identifier based on combining the vector representation of the product caption and the vector representation of the image. Combining the vector representation of the product caption and the vector representation of the image may comprise concatenating the vector representation of the image and the vector representation of the product caption.

At block 312, store the product identifier in a product index comprising a plurality of product identifiers, wherein the product index is searchable to identify the product identifier based on a submitted query. The product index may support cross-modal searching using image queries or text queries. The product identifier may be associated with a name of a product. Storing the product identifier in the product index may comprise storing the product identifier in association with the product.

The method may further comprise accessing a second image comprising the product, wherein the second image is associated with a submitted query, generating a second vector representation of the second image, and utilizing the multimodal artificial intelligence engine, generating a second product caption of the product, the second product caption comprising contextual data describing the product within the second image. The method may further comprise generating a second vector representation of the second product caption, generating a second product identifier based on combining the second vector representation of the second product caption and the second vector representation of the second image, comparing the second product identifier to the plurality of product identifiers in the product index, and based on comparing the second product identifier to the plurality of product identifiers, identifying a query response product identifier as a response to the submitted query. The image associated with query response product identifier may be communicated to a user. For example, the caption-based enhanced retrieval engine may transmit the image to the image processing client 190 which may cause display of the image on a user device associated with the image processing client 190.

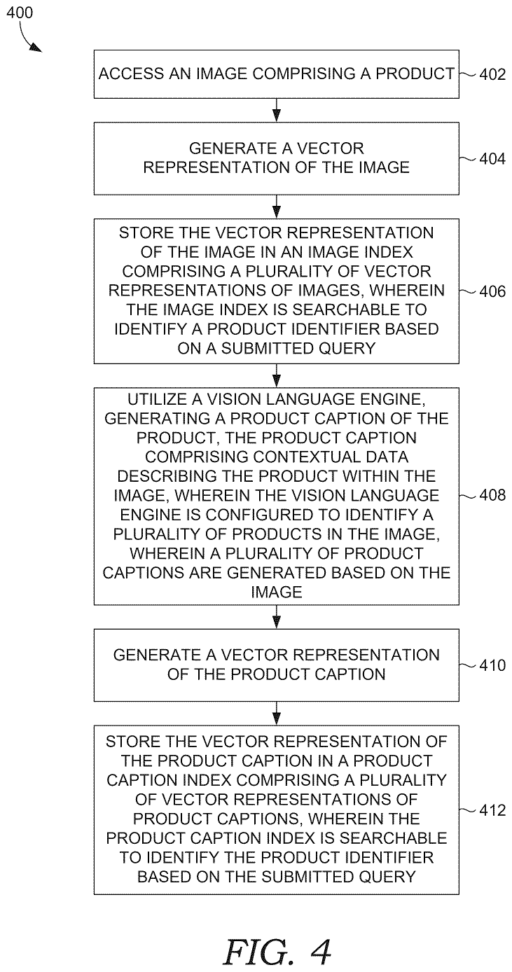

Turning to FIG. 4, a flow diagram is provided that illustrates a method 400 for generating and storing image identifiers based on generated captions. At block 402, accessing an image comprising a product. At block 404, generate a vector representation of the image. At block 406, store the vector representation of the image in an image index comprising a plurality of vector representations of images, wherein the image index is searchable to identify a product identifier based on a submitted query.

At block 408, utilizing a multimodal artificial intelligence engine, generate a product caption of the product, the product caption comprising contextual data describing the product within the image, wherein the multimodal artificial intelligence engine is configured to identify a plurality of products in the image, wherein a plurality of product captions are generated based on the image.

At block 410, generate a vector representation of the product caption. At step 412, store the vector representation of the product caption in a product caption index comprising a plurality of vector representations of product captions, wherein the product caption index is searchable to identify the product identifier based on the submitted query. The method may further comprise accessing a submitted query comprising a second image of a second product, generating a second vector representation of the second image, utilizing a multimodal artificial intelligence engine, generating a second product caption of the second product, the second product caption comprising contextual data describing the second product within the second image, and generating a second vector representation of the second product caption.

In additional or alternative embodiments, the method may comprise comparing the second vector representation of the second image to the plurality of vector representations of images stored in the image index, comparing the second vector representation of the second product caption to the plurality of vector representations of product captions stored in the product caption index. The second vector representation may be compared with the plurality of vector representations through any known method of vector comparison. For example, the second vector representation may be compared against the plurality of vector representation based on similarity metrics such as cosine similarity or Euclidean distance. Based on these comparisons, the plurality of vectors may be ranked based on computed similarity to the second vector representation. Based on comparing the second vector representation of the second product caption to the plurality of vector representations of product captions and comparing the second vector representation of the second image to the plurality of vector representations of images, identifying a query response product identifier, and communicating the query response product identifier as a response to the submitted query. The query response product identifier may be stored in a query response index in association with the second product.

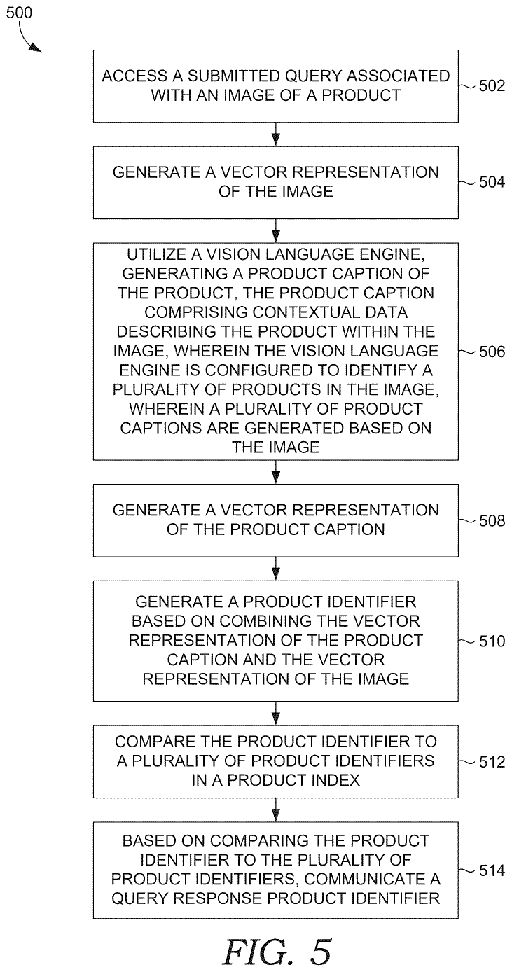

Turning to FIG. 5, a flow diagram is provided that illustrates a method 500 for generating and storing image identifiers based on generated captions. At block 502, access a submitted query associated with an image of a product. At block 504, generate a vector representation of the image. At block 506, utilizing a multimodal artificial intelligence engine, generate a product caption of the product, the product caption comprising contextual data describing the product within the image, wherein the multimodal artificial intelligence engine is configured to identify a plurality of products in the image, wherein a plurality of product captions are generated based on the image. The product caption may further comprise a name of the product. At block 508, generate a vector representation of the product caption. At block 510, generate a product identifier based on combining the vector representation of the product caption and the vector representation of the image. At block 512, compare the product identifier to a plurality of product identifiers in a product index. At block 514, based on comparing the product identifier to the plurality of product identifiers, communicate a query response product identifier.

### Technical Improvement

Embodiments of the present invention have been described with reference to several inventive features (e.g., operations, systems, engines, and components) associated with an item listing system. Inventive features described include: operations, interfaces, data structures, and arrangements of computing resources associated with providing the functionality described herein relative with reference to a caption-based enhanced retrieval engine associated with an image processing system.

Embodiments of the present invention relate to the field of computing, and more particularly to an image processing system and item listing system. The following described exemplary embodiments provide a system, method, and program product to, among other things, process images to generate captions that describe any number of products in a textual description that captures the context and subtext of the products within the image These captions may then be transformed into caption vectors and stored in association with image vectors representing visual features of the image. Therefore, the present embodiments improve the technical field of image processing systems and item listing systems enhancing the efficiency and effectiveness of generating embeddings and querying databases such as those utilized by item listing systems. For example, the caption-based enhanced retrieval engine processes images to generate captions that describe any number of products in a textual description that captures the context and subtext of the products within the image. These captions may then be transformed into caption vectors and stored in association with image vectors representing visual features of the image. As such, the caption-based enhanced retrieval engine provides a particularly efficient and accurate search and storage system allowing for the utilization of caption data in the form of text data describing products within an image in the context of the image. This increases the accuracy of potential searches by more accurately capturing the contextual and subtextual data of products within the context of an overall image. This provides for an improvement to technology by creating an efficient embedding generation and storage system that may be queried for more robust and accurate results.

Functionality of the embodiments of the present invention have further been described, by way of an implementation and anecdotal examples—to demonstrate that the operations for generating and storing embeddings based on generated image captions in an image process system and item listing system as a solution to a specific problem in image processes, storage, and retrieval technologies to improve computing operations in image processing and item listing systems. Overall, these improvements result in less CPU computation, smaller memory requirements, and increased flexibility in image processing systems and item listing systems when compared to previous conventional image processing system and item listing system operations performed for similar functionality.

### Additional Support for Detailed Description of the Invention

### Example Item Listing System Environment

Referring now to FIG. 6, FIG. 6 illustrates an example item listing system 600 computing environment in which implementations of the present disclosure may be employed. In particular, FIG. 6 shows a high-level architecture of an example item listing platform 610 that can host a technical solution environment, or a portion thereof. It should be understood that this and other arrangements described herein are set forth as examples. For example, as described above, many elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The item listing system 600 can be a cloud computing environment that provides computing resources for functionality associated with the item listing platform 610. For example, the item listing system 600 supports delivery of computing components and services-including servers, storage, databases, networking, applications, and machine learning associated with the item listing platform 610 and client device 620. A plurality of client devices (e.g., client device 620) include hardware or software that access resources on the item listing system 600. Client device 620 can include an application (e.g., client application 622) and interface data (e.g., client application interface data 624) that support client-side functionality associated with the item listing system. The plurality of client devices can access computing components of the item listing system 600 via a network (e.g., network 626) to perform computing operations.

The item listing platform 610 is responsible for providing a computing environment or architecture that includes the infrastructure that supports providing item listing platform functionality (e.g., e-commerce functionality). The item listing platform support storing item in item databases and providing a search system for receiving queries and identifying search results based on the queries. The item listing platform may also provide a computing environment with features for managing, selling, buying, and recommending different types of items. Item listing platform 610 can specifically be for a content platform such as EBAY content platform or e-commerce platform, developed by EBAY INC., of San Jose, California.

The item listing platform 610 can provide item listing operations 630 and item listing interfaces 640. The item listing operations 630 can include service operations, communication operations, resource management operations, security operations, and fault tolerance operations that support specific tasks or functions in the item listing platform 610. The item listing interfaces 640 can include service interfaces, communication interfaces, resource interfaces, security interfaces, and management and monitoring interfaces that support functionality between the item listing platform components. The item listing operations 630 and item listing interfaces 640 can enable communication, coordination and seamless functioning of the item listing system 600.

By way of example, functionality associated with item listing platform 610 can include shopping operations (e.g., product search and browsing, product selection and shopping cart, checkout and payment, and order tracking); user account operations (e.g., user registration and authentication, and user profiles); seller and product management operations (e.g., seller registration and product listing and inventory management); payment and financial operations (e.g., payment processing, refunds and returns); order fulfillment operations (e.g., order processing and fulfillment and inventory management); customer support and communication interfaces (e.g., customer support chat/email and notifications); security and privacy interfaces (e.g., authentication and authorization, payment security); recommendation and personalization interfaces (e.g., product recommendations and customer reviews and ratings); analytics and report interfaces (e.g., sales and inventory reports, and user behavior analytics); and APIs and Integration Interfaces (e.g., APIs for Third-Party Integration).

The item listing platform 610 can provide item listing platform databases (e.g., item listing platform databases 650) to manage and store different types of data efficiently. The item listing platform databases 650 can include relational databases, NoSQL databases, search databases, cache databases, content management systems, analytics databases, payment gateway database, customer relationship management databases, log and error databases, inventory and supply chain databases, and multi-channel databases that are used in combination to efficiently manage data and provide e-commerce experience for users.

The item listing platform 610 supports applications (e.g., applications 660) that is a computer program or software component or service that serves a specific function or set of functions to fulfil a particular item listing platform requirement or user requirement. Applications can be client-side (user-facing) and server-side (backend). Applications can also include application without any AI support (e.g., application 662) application supported by traditional AI model (e.g., application 664), and applications supported by generative AI models (e.g., application 666). By way of example, applications can include an online storefront application, mobile shopping app, admin and management console, payment gateway integration, user account and authentication application, search and recommendation engines, inventory and stock management application, order processing and fulfillment application, customer support and communication tools, content management system, analytics and report applications, marketing and promotion applications, multi-channel integration applications, log and error tracking applications, customer relationship management (CRM) applications, security applications, and APIs and web services that are used in combination to efficiently deliver e-commerce experiences for users.

The items listing platform 610 can include a machine learning engine (e.g., machine learning engine 670). The machine learning engine 670 refers to machine learning framework or machine learning platform that provides the infrastructure and tools to design, train, evaluate, and deploy machine learning models. The machine learning engine 670 can serve as the backbone for developing and deploying machine learning applications and solutions. Machine learning engine 670 can also provide tools for visualizing data and model results, as well as interpreting model decisions to gain insights into how the model is making predictions.

The machine learning engine 670 can provide the necessary libraries, algorithms, and utilities to perform various tasks within the machine learning workflow. The machine learning workflow can include data processing, model selection, model training, model evaluation, hyperparameter tuning, scalability, model deployment, inference, integration, customization, data visualization. Machine learning engine 670 can include pre-trained models for various tasks, simplifying the development process. In this way, the machine learning engine 670 can streamline the entire machine learning process, from data preparation and model training to deployment and inference, making it accessible and efficient for different types of users (e.g., customers, data scientists, machine learning engineers, and developers) working on a wide range of machine learning applications.

Machine learning engine 670 can be implemented in the item listing system 600 as a component that leverages machine learning algorithms and techniques (e.g., machine learning algorithms 672) to enhance various aspects of the secure vault engine functionality. Machine learning engine 670 can provide a selection of machine learning algorithms and techniques used to teach computers to learn from data and make predictions or decisions without being explicitly programmed. These techniques are widely used in various applications across different industries, and can include the following examples: supervised learning (e.g., linear regression: classification, support vector machines (SVM) ; unsupervised learning (e.g., clustering, principal component analysis (PCA) , association rules (e.g., apriori); reinforcement learning (e.g., Q-Learning, deep Q-Network (DQN); and deep learning (e.g., neural networks, convolutional neural networks (CNN), and recurrent neural networks (RNN); and ensemble learning random forest.

Machine learning training data 674 supports the process of building, training, and fine-tuning machine learning models. Machine learning training data 674 consists of a labeled dataset that is used to teach a machine learning model to recognize patterns, make predictions, or perform specific tasks. Training data typically comprises two main components: input feature (X) and labels or target values (Y) . Input features can include variables, attributes, or characteristics used as input to the machine learning model. Input features (X) can be numeric, categorical, or even textual, depending on the nature of the problem. For example, in a model for predicting house prices, input features might include the number of bedrooms, square footage, neighborhood, and so on. Labels or target values (Y) include the values that the model aims to predict or classify. Labels represent the desired output or the ground truth for each corresponding set of input features. For instance, in a spam email classifier, the labels would indicate whether each email is spam or not (i.e., binary classification). The training process involves presenting the model with the training data, and the model learns to make predictions or decisions by identifying patterns and relationships between the input features (X) and the target values (Y). A machine learning algorithm adjusts its internal parameters during training in order to minimize the difference between its predictions and the actual labels in the training data. Machine learning engine 670 can use historical and real-time data to train models and make predictions, continually improving performance and user experience.

Machine learning engine 670 can include machine learning models (e.g., machine learning models 676) generated using the machine learning engine workflow. Machine learning models 676 can include generative A I models and traditional AI models that can both be employed in the item listing system 600. Generative AI models are designed to generate new data, often in the form of text, images, or other media, based on patterns and knowledge learned from existing data. Generative AI models can be employed in various ways including content generation, product image generation, personalized product recommendations, natural language chatbots, and content summarization. Traditional AI models encompass a wide range of algorithms and techniques and can be employed in various ways including recommendation systems, predictive analytics, search algorithms, fraud detection, customer segmentation, image classification, Natural Language Processing (NLP) and A/B testing and optimization. In many cases, a combination of both generative and traditional AI models can be employed to provide a well-rounded and effective e-commerce experience, combining data-driven insights and creativity.

Machine learning engine 670 can be used to analyze data, make predictions, and automate processes to provide a more personalized and efficient shopping experience for users. By way of example, product recommendations search and filtering: pricing optimization, inventory and stock management: customer segmentation, churn prediction and retention, fraud detection, sentiment analysis, customer support and chatbots, image and video analysis, and ad targeting and marketing. The specific applications of machine learning within the item listing platform 610 can vary depending on the specific goals, available data, and resources.

### Example Distributed Computing System Environment

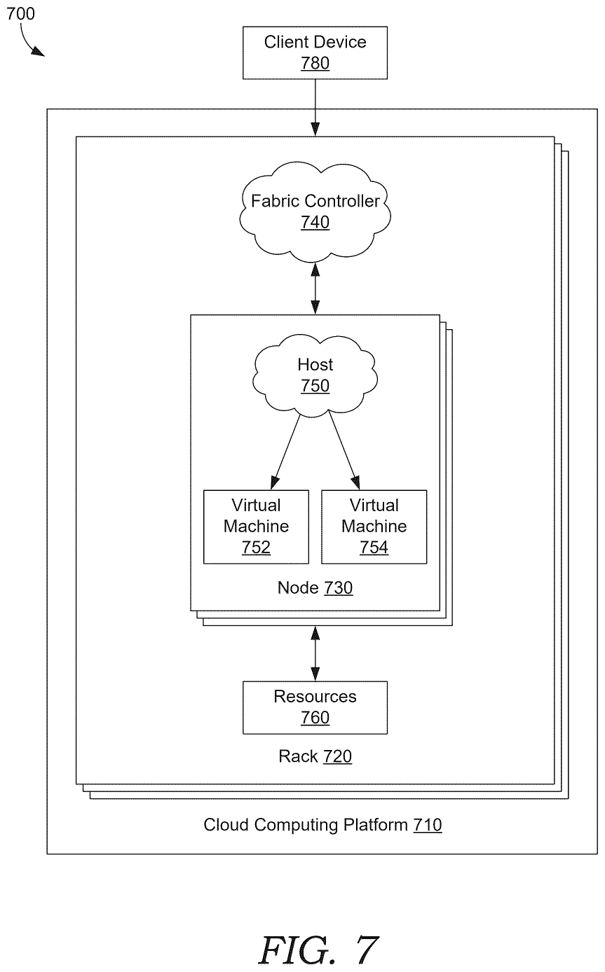

Referring now to FIG. 7, FIG. 7 illustrates an example distributed computing environment 700 in which implementations of the present disclosure may be employed. In particular, FIG. 7 shows a high-level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. Cloud computing platform 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 800 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LA Ns) and/or wide area networks (WANs).

### Example Computing Environment

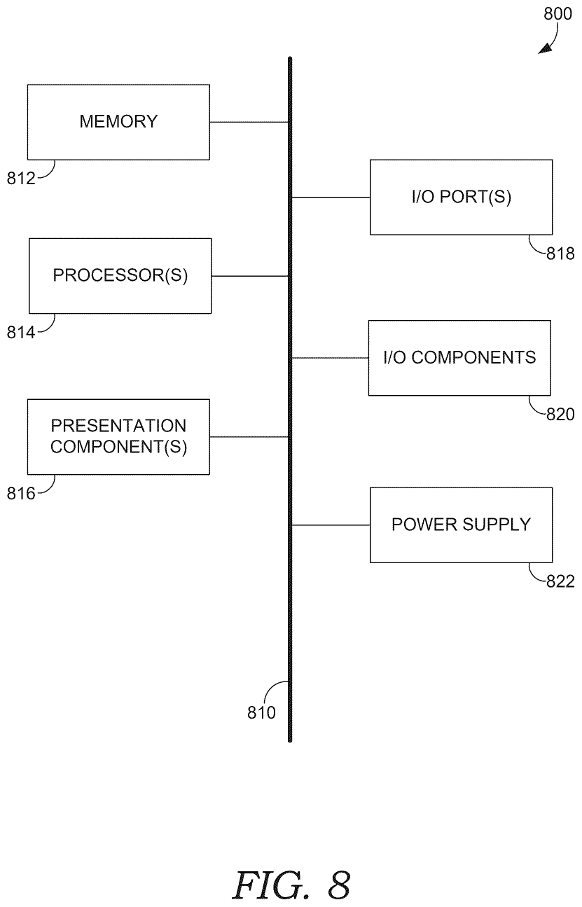

Having briefly described an overview of embodiments of the present invention, an example operating environment in which embodiments of the present invention may be implemented is described below in order to provide a general context for various aspects of the present invention. Referring initially to FIG. 8 in particular, an example operating environment for implementing embodiments of the present invention is shown and designated generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art and reiterate that the diagram of FIG. 8 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.” Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious, and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing an image comprising a product;
generating a vector representation of the image;
utilizing a multimodal artificial intelligence engine, generating a product caption of the product, the product caption comprising contextual data describing the product within the image, wherein the multimodal artificial intelligence engine is configured to identify a plurality of products in the image, wherein a plurality of product captions are generated based on the image;
generating a vector representation of the product caption;
generating a product identifier based on combining the vector representation of the product caption and the vector representation of the image; and
storing the product identifier in a product index comprising a plurality of product identifiers, wherein the product index is searchable to identify the product identifier based on a submitted query.

2. The system of claim 1, wherein the operations further comprise:
accessing a second image comprising the product, wherein the second image is associated with a submitted query;
generating a second vector representation of the second image;
utilizing the multimodal artificial intelligence engine, generating a second product caption of the product, the second product caption comprising contextual data describing the product within the second image;
generating a second vector representation of the second product caption;
generating a second product identifier based on combining the second vector representation of the second product caption and the second vector representation of the second image;
comparing the second product identifier to the plurality of product identifiers in the product index; and
based on comparing the second product identifier to the plurality of product identifiers, identifying a query response product identifier as a response to the submitted query.

3. The system of claim 2, wherein the operations further comprise:
communicating an image associated with the query response product identifier.

4. The system of claim 1, wherein the image comprises a plurality of products.

5. The system of claim 4, wherein the product caption is generated based on receiving a selection of one of the plurality of products within the image.

6. The system of claim 4, wherein a plurality of product captions are generated based on the image.

7. The system of claim 1, wherein the vector representation of the product caption is generated by an image embedding model trained through contrastive learning utilizing caption and image pairs.

8. The system of claim 1, wherein storing the product identifier in the product index comprises storing the product identifier in association with the product.

9. The system of claim 1, wherein generating the product caption comprises generating the product caption based on a prompt requesting a description of the product within the image.

10. The system of claim 1, wherein combining the vector representation of the image and the vector representation of the product caption comprises concatenating the vector representation of the image and the vector representation of the product caption.

11. The system of claim 1, wherein the product index supports cross-modal searching using image queries or text queries.

12. A computer-implemented method, the computer-implemented method comprising:
accessing an image comprising a product;
generating a vector representation of the image;
utilizing a multimodal artificial intelligence engine, generating a product caption of the product, the product caption comprising contextual data describing the product within the image, wherein the multimodal artificial intelligence engine is utilized to identify a plurality of products in the image, wherein a plurality of product captions are generated based on the image;
generating a vector representation of the product caption;
storing the vector representation of the image in an image index comprising a plurality of vector representations of images, wherein the image index is searchable to identify a product identifier based on a submitted query; and
storing the vector representation of the product caption in a product caption index comprising a plurality of vector representations of product captions, wherein the product caption index is searchable to identify the product identifier based on the submitted query.

13. The computer-implemented method of claim 12, wherein the method further comprises:
accessing a submitted query comprising a second image of the product;
generating a second vector representation of the second image;
utilizing a multimodal artificial intelligence engine, generating a second product caption of the product, the second product caption comprising contextual data describing the product within the second image;
generating a second vector representation of the second product caption;
comparing the second vector representation of the second image to the plurality of vector representations of images stored in the image index;
comparing the second vector representation of the second product caption to the plurality of vector representations of product captions stored in the product caption index;
based on comparing the second vector representation of the second product caption to the plurality of vector representations of product captions and comparing the second vector representation of the image to the plurality of vector representations of images, identifying a query response product identifier; and
communicating the query response product identifier as a response to the submitted query.

14. The computer-implemented method of claim 12, wherein the method further comprises:
accessing a submitted query comprising a second image of a second product;
generating a second vector representation of the second image;
utilizing a multimodal artificial intelligence engine, generating a second product caption of the second product, the second product caption comprising contextual data describing the second product within the second image;
generating a second vector representation of the second product caption;
comparing the second vector representation of the second image to the plurality of vector representations of images stored in the image index;
comparing the second vector representation of the second product caption to the plurality of vector representations of product captions stored in the product caption index;
based on comparing the second vector representation of the second product caption to the plurality of vector representations of product captions and comparing the second vector representation of the second image to the plurality of vector representations of images, identifying a query response product identifier; and
communicating the query response product identifier as a response to the submitted query.

15. The computer-implemented method of claim 14, further comprising:
storing the query response product identifier in a query response index in association with the second product.

16. One or more computer-storage media having computer-executable instructions embodied thereon that, when executed by a computing system having a processor and memory, cause the processor to perform operations, the operations comprising:
accessing a submitted query associated with an image of a product;
generating a vector representation of the image;
utilizing a multimodal artificial intelligence engine, generating a product caption of the product, the product caption comprising contextual data describing the product within the image, wherein the multimodal artificial intelligence engine is configured to identify a plurality of products in the image, wherein a plurality of product captions are generated based on the image;
generating a vector representation of the product caption;
generating a product identifier based on combining the vector representation of the product caption and the vector representation of the image;
comparing the product identifier to a plurality of product identifiers in a product index; and
based on comparing the product identifier to the plurality of product identifiers, communicating a query response product identifier.

17. The media of claim 16, wherein the product index supports cross-modal searching using image queries or text queries.

18. The media of claim 16, wherein the product caption further comprises a name of the product.

19. The media of claim 16, wherein generating the product caption comprises generating the product caption based on a prompt requesting a description of the product within the image.

20. The media of claim 16, wherein combining the vector representation of the product caption and the vector representation of the image comprises concatenating the vector representation of the product caption and the vector representation of the image.
